(19) United States
(12) Patent Application Publication
(10) Pub. No.: US 2008/0158256 A1
(43) Pub. Date: Jul. 3, 2008

(54) Method and system for providing a perspective view image by intelligent fusion of a plurality of sensor data

(75) Inventors: Richard Russell, Windermere, FL (US); Terence Hoehn, Clermont, FL (US); Alexander T. Shepherd, Plant City, FL (US)

Correspondence Address: BIRCH STEWART KOLASCH & BIRCH, PO BOX 747, FALLS CHURCH, VA, 22040-0747, US

(73) Assignee: Lockheed Martin Corporation, Bethesda, MD (US)

(21) Appl. No.: 11/819,149

(22) Filed: Jun. 25, 2007

Related U.S. Application Data
(60) Provisional application No. 60/816,350, filed on Jun. 26, 2006.

(51) Int. Cl. G09G 5/00

(52) U.S. Cl. 345/629

(57) ABSTRACT

A method and system for providing a perspective view image created by fusing a plurality of sensor data for supply to a platform operator with a desired viewing perspective within an area of operation is disclosed. A plurality of sensors provide substantially real-time data of an area of operation, a processor combines the substantially real-time data of the area of operation with digital terrain elevation data of the area of operation and positional data of a platform operator to create a digital cartographic map database having substantially real-real time sensor data, a memory for storing the digital cartographic map database, a perspective view data unit inputs data regarding a desired viewing perspective of the operator within the area of operation with respect to the digital cartographic map database to provide a perspective view image of the area of operation, and a display for displaying the perspective view image to the operator.

### CROSS-REFERENCE

This application claims the benefit of U.S. provisional Application Ser. No. 60/816,350 filed Jun. 26, 2006.

### TECHNICAL FIELD

The present invention relates generally to data fusion for providing a perspective view image created by fusing a plurality of sensor data for supply to a platform operator (e.g., a pilot operating a rotary or fixed wing aircraft, an unmanned ground vehicle (UGV) operator, an unmanned aerial vehicle (UAV) operator, or even a foot soldier on a battlefield). It particularly relates to a method and apparatus for intelligent fusion of position derived synthetic vision with optical vision (SynOptic Vision®), either from the operator's eye or an aided optical device in either a visible or other spectral regions of the electromagnetic spectrum.

### BACKGROUND OF THE INVENTION

Currently, sensor systems incorporating a plurality of sensors (multi-sensor) are widely used for a variety of military applications including ocean surveillance, air-to-air and surface-to-air defense, battlefield intelligence, surveillance and target detection, and strategic warning and defense. Also, multi-sensor systems are used for a plurality of civilian applications including condition-based maintenance, robotics, automotive safety, remote sensing, weather forecasting, medical diagnoses, and environmental monitoring (e.g., weather forecasting).

For military applications, a sensor-level fusion process is widely used wherein data received by each individual sensor is fully processed at each sensor before being output to a system data fusion processor. The data (signal) processing performed at each sensor may include a plurality of processing techniques to obtain desired system outputs (target reporting data) such as feature extraction, and target classification, identification, and tracking.

Further, for military applications, improved situational awareness (SA), navigation, pilotage, targeting, survivability, flight safety, and training are particularly important in order to accomplish desired missions. Factors currently inhibiting the above items include inability to see in darkness, inclimate weather, battlefield obscurants, terrain intervisibility constraints, pilot workload too high due to multiple sensor inputs, and obstacle avoidance.

For example, currently, operations of UAV operators are hindered by limited SA due to a lack of “out the window” perspective and a narrow field-of-view (FOV) provided by the UAV sensors. Similarly, UGV operators are hindered by line-of-sight imitations of a land vehicle driver as well as with a narrow FOV of onboard sensors much like UAV operators.

Therefore, due to the disadvantages mentioned above, there is a need to provide a method and system that gives the platform operator a wide field SA and aids positioning of onboard sensors remotely. There is also a need for the platform operator so that the operator's view can be steered in six-degree-of-freedom (6-DOF) space to look over, beyond, and through physical obstacles such as hills and buildings. Also, there is a need to provide a vision to the platform operator that reduces or eliminates smoke, dust, or weather obscuration for navigation, SA and fire control.

### SUMMARY OF THE INVENTION

The method and system of the present invention overcome the previously mentioned problems by taking three-dimensional (3D) digital cartography data from a simulator to a tactical platform, through 6-DOF location awareness inputs and 6-DOF steering commands and fusing real-time two-dimensional (2D) and 3D radio frequency (RF) and elector-optical (EO) imaging and other sensor data with the spatially referenced digital cartographic data.

According to one embodiment of the present invention, a method for providing a perspective view image is disclosed. The method includes providing a plurality of sensors configured to provide substantially real-time data of an area of operation, combining the substantially real-time data of the area of operation with digital terrain elevation data of the area of operation and positional data of a platform operator to create a digital cartographic map database having substantially real-real time sensor data, inputting data regarding a desired viewing perspective within the area of operation with respect to the digital cartographic map database to provide a perspective view image of the area of operation, and displaying the perspective view image to the operator.

According to one embodiment of the present invention, a system for providing a perspective view image is disclosed. A plurality of sensors provide substantially real-time data of an area of operation, a processor combines the substantially real-time data of the area of operation with digital terrain elevation data of the area of operation and positional data of a platform operator to create a digital cartographic map database having substantially real-real time sensor data, a memory for storing the digital cartographic map database, a perspective view data unit inputs data regarding a desired viewing perspective of the operator within the area of operation with respect to the digital cartographic map database to provide a perspective view image of the area of operation, and a display for displaying the perspective view image to the operator.

According to one embodiment of the present invention, a computer readable storage medium having stored thereon computer executable program for providing a perspective view image is disclosed. The computer program when executed causes a processor to perform the steps of providing substantially real-time data of an area of operation, combining the substantially real-time data of the area of operation with digital terrain elevation data of the area of operation and positional data of a platform operator to create a digital cartographic map database having substantially real-real time sensor data, inputting data regarding a desired viewing perspective within the area of operation with respect to the digital cartographic map database to provide a perspective view image of the area of operation, and displaying the perspective image to the operator.

According to an aspect of the present invention, there is provided a method for providing real-time positional imagery to an operator, comprising: combining three dimensional digital cartographic imagery with real-time global positioning (GPS) data and inertial navigation data, translating the combined imagery data into real-time positional imagery; and displaying the translated positional imagery to the operator. The above mentioned method may further comprise: receiving updated GPS data regarding the operators current position, and updating the positional imagery to reflect the operator's current position based on the updated GPS data. The mentioned method may further comprise: receiving a steering command from the operator, and updating the displayed view of the translated positional imagery in accordance with the received steering command.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The accompanying drawings, which are incorporated in and constitute a part of this specification, illustrate several embodiments of the invention and together with the description, serve to explain the principles of the invention.

FIG. 1 is a block diagram of a general purpose system in accordance with embodiments of the present invention.

FIG. 2 is a functional block diagram of a perspective view imaging system in accordance with an embodiment of the present invention.

FIG. 3 illustrates a functional block diagram which describes the basic functions performed in the perspective view imaging system of FIG. 2.

FIG. 4 illustrates a more detailed block diagram describing the functions performed in the perspective view imaging system of FIG. 2.

FIG. 5 shows a flow diagram illustrating operations performed by a perspective view imaging system according to an embodiment of the present invention illustrated in FIG. 4.

FIG. 6 shows a more detailed flow diagram illustrating operations performed by a perspective view imaging system according to an embodiment of the present invention illustrated in FIG. 4.

FIG. 7 shows a general method by which perspective view imaging may be employed by three different illustrative platform operators.

FIG. 8 shows an exemplary application of perspective view imaging to a rotary wing aircraft according to an embodiment of the present invention.

FIG. 9 shows an exemplary application of perspective view imaging to a foot soldier according to an embodiment of the present invention.

FIG. 10 shows an exemplary application of perspective view imaging to a land vehicle operator according to an embodiment of the present invention.

FIG. 11 shows an exemplary application of perspective view imaging to an UAV operator according to an embodiment of the present invention.

FIG. 12 shows an exemplary application of perspective view imaging to an UGV operator according to an embodiment of the present invention.

FIG. 13 shows an exemplary application of perspective view imaging to an operator of a high/fast fixed wing aircraft according to an embodiment of the present invention.

### DETAILED DESCRIPTION

The following detailed description of the embodiments of the invention refers to the accompanying drawings. The following detailed description does not limit the invention. Instead, the scope of the invention is defined by the appended claims and equivalents thereof.

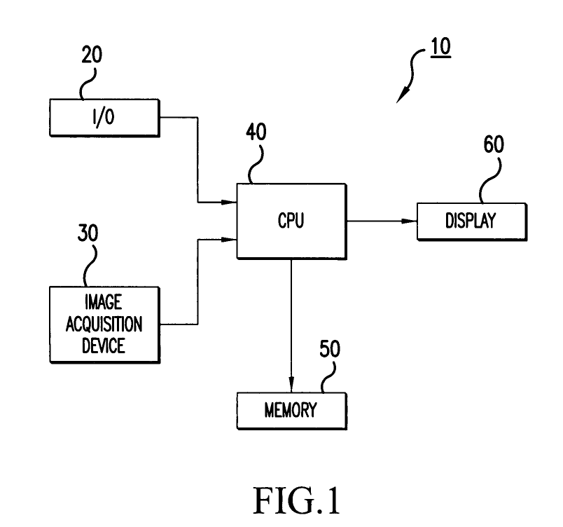

FIG. 1 illustrates a general purpose system 10 that may be utilized to perform the methods and algorithms disclosed herein. The system 10 shown in FIG. 1 includes an Input/Output (I/O) device 20, an image acquisition device 30, a Central Processing Unit (CPU) 40, a memory 50, and a display 60. This apparatus and particularly the CPU 40 may be specially constructed for the inventive purposes such as a programmed digital signal processor (DSP), an application specific integrated circuit (ASIC), a field programmable gate array (FPGA) or special purpose electron circuit, or it may comprise a general-purpose computer selectively activated or reconfigured by a computer program stored in the memory 50. Such a computer program may be stored in the memory 50, which may be a computer readable storage medium, such as, but is not limited to, any type of disk (including floppy disks, optical disks, CD-ROMs, and magnetic-optical disks) or solid-state memory devices such as a read-only memory ROM, random access memory (RAM), EPROM, EEPROM, magnetic or optical cards, or any type of computer readable media suitable for storing electronic instructions.

The algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description herein. In addition, the present invention is not described with reference to any particular programming language. It will be appreciated that a variety of programming languages may be used to implement the teachings of the invention as described herein.

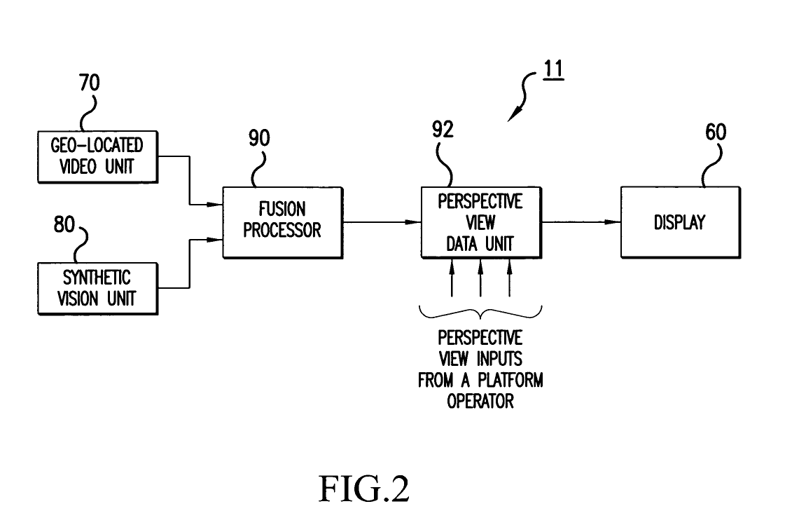

FIG. 2 shows a functional block diagram of an exemplary perspective view imaging system 11 in accordance with embodiments of the present invention. Advantageously, the perspective view imaging system 11 may include a synthetic vision unit 70, a geo-located video unit 80, a fusion processor 90, a perspective view data unit 92, and a display 60.

In accordance with an exemplary embodiment of the present invention, one end of the fusion processor 90 is connected with the synthetic vision unit 70 and the geo-located video unit 80 and the other end of the fusion processor 90 is connected with an input line of the perspective view data unit 92. An output line of the perspective view data unit 92 is connected with the display 60. The expression “connected” as used herein and in the remaining disclosure is a relative term and does not require a direct physical connection. In operation, the fusion processor 90 receives outputs from the synthetic vision unit 70 and the geo-located video unit 80 and outputs a combined data. The perspective view data unit 92 receives inputs regarding a desired viewing perspective of a platform operator within an area of operation with respect to the combined data and outputs a perspective view image of the area of operation to the display 60. For example, in military applications, when the area of operation includes a battlefield, perspective view image outputted from the perspective view data unit 92 allows an operator (e.g., a pilot, an UAV operator, an UGV operator or even a foot soldier) to view the battlefield from whatever perspective the operator wants to see it.

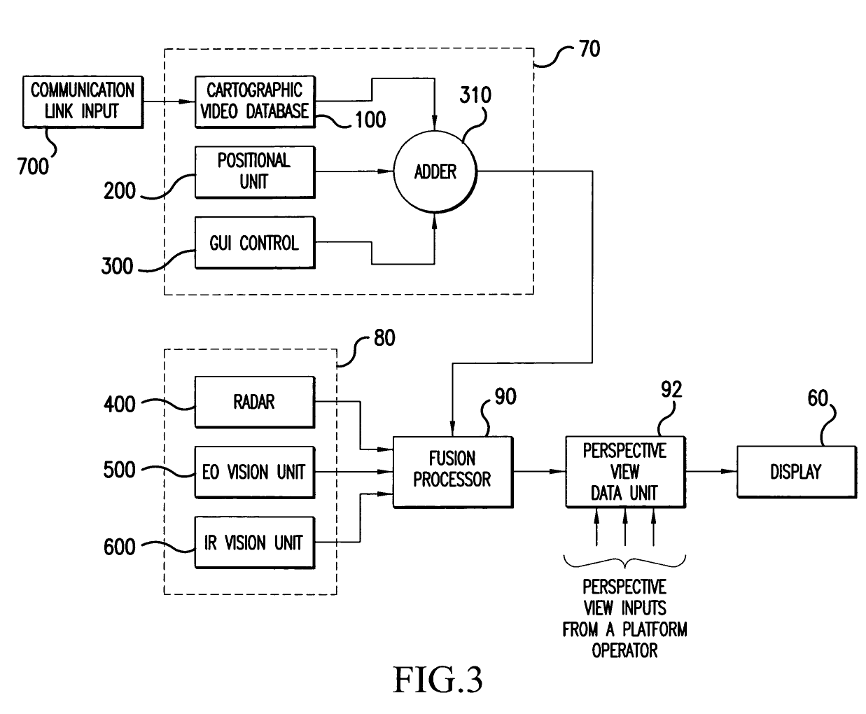

FIG. 3 shows a functional block diagram which describes the basic functions performed in the exemplary Perspective view imaging system 11 of FIG. 2 in accordance with an embodiment of the present invention. Advantageously, the synthetic vision unit 70 may include a cartographic video database 100, a positional unit 200, a graphical user interface (GUI) control 300 and an adder 310. The positional unit 200 may include, but not limited to, a global positioning system (GPS), an inertial navigation system (INS), and/or any other equivalent systems that provide positional data. The geo-located video unit 80 may include a radar 400, an electro-optical (EO) vision unit 500, an infra-red (IR) vision unit 600. The geo-located video unit 80 may include other equivalent units that provide geo-located still or motion imagery.

In accordance with an exemplary embodiment of the present invention, one end of the cartographic video database 100 is connected to an input line of the adder 310 and the other end of the cartographic video database 100 is connected to a communication link input 700. The positional unit 200 and the GUI control 300 are also connected to other input lines of the adder 310. An output line of the adder 310 is connected to an input line of the fusion processor 90. The radar 400, EO vision unit 500, and the IR vision unit 600 are also connected to other input lines of the fusion processor 90. An output line of the fusion processor 90 is connected with an input line of the perspective view data unit 92. An output line of the perspective view data unit 92 is connected with the display 60.

The basic function of the perspective view imaging system 11 may be independent of the platform, vehicle, or location in which a human operator is placed, or over which that operator has control. Perspective view imaging concept may be used for, but are not limited to: mission planning, post-mission debrief, and battlefield damage assessment (BDA); assisting the control station operator of either an unmanned ground vehicle (UGV) or an unmanned aerial vehicle (UAV); augmenting the capabilities of a foot soldier or combatant; assisting in the navigation and combat activities of a military land vehicle; navigation, landing, situational awareness and fire control of a rotary wing aircraft; navigation, landing, situational awareness and fire control of a low altitude, subsonic speed fixed wing aircraft; situational awareness and targeting function in high altitude sonic and supersonic combat aircraft. Each of the above listed applications of Perspective view imaging may have a common concept functions described in FIG. 3, but may each have individual and differing hardware and software embodiments, which is individually described in later sections of this disclosure.

In accordance with an exemplary embodiment of the present invention, outputs from the cartographic video database 100 is combined with the outputs of the positional unit 200 and GUI control 300 by the adder 310. This combined data is received by the fusion processor 90, which fuses this combined data with outputs from the radar 400, EO vision unit 500, and the IR vision unit 600. The GUI control 300 may include, but not limited to, a joy stick, thumbwheel, or other control input device which provides six-degree-of-freedom (6-DOF) inputs. The cartographic video database 100 may include three-dimensional (3D) high definition cartographic data (e.g., still of video imagery of a battlefield), which is combined with inputs from the positional unit 200 to effectively place a real-time real-world position of the operator in 6-DOF space with regard to the cartographic data. Thus, when the operator's position moves, it is translated to a new view of the three dimensional cartographic data and, therefore, if displayed on the display 60, would represent that data to the operator as though he were viewing the real-world around him, as recorded at the time of the cartographic data generation. The image provided by this above described manner is called a synthetic vision image, which is displayed on the display 60.

In addition to the geo-reference data provided by the geo-located video unit 80, 6-DOF steering commands may be used to alter the reference position in space and angular position to allow the operator to move his displayed synthetic vision image with respect to his position. For example, the operator may steer this virtual image up, down, right, left, or translate the position of viewing a distance overhead or out in front of his true position by any determined amount. This process also allows a change in apparent magnification or its accompanying field of view (FOV) of this synthetic image. The process thus described is one of creating position located 3D synthetic vision.

This synthetic vision, so derived is combined in the fusion processor 90 in three dimensional spatial manipulations with some combination of either EO sensor imagery provided by the EO vision unit 500, IR sensor imagery provided by the IR vision unit 600, intensified or low-light level imagery, radar three dimensional imagery provided by the radar 400, range data, or other sources of intelligence. The result of the fusion of this synthetic vision with one or more of these types of imagery and data, as well as real-world vision by the human eyeball, is defined as perspective view imaging.

FIG. 3 further illustrates a means whereby changes to the cartographic video database 100 are made via inputs from the communication link input 700. This change data may be provided using conventional low bandwidth (e.g., 25K bits/second) by only transmitting changes in individual pixels in the data rather than completely replacing a scene stored in the cartographic video database 100.

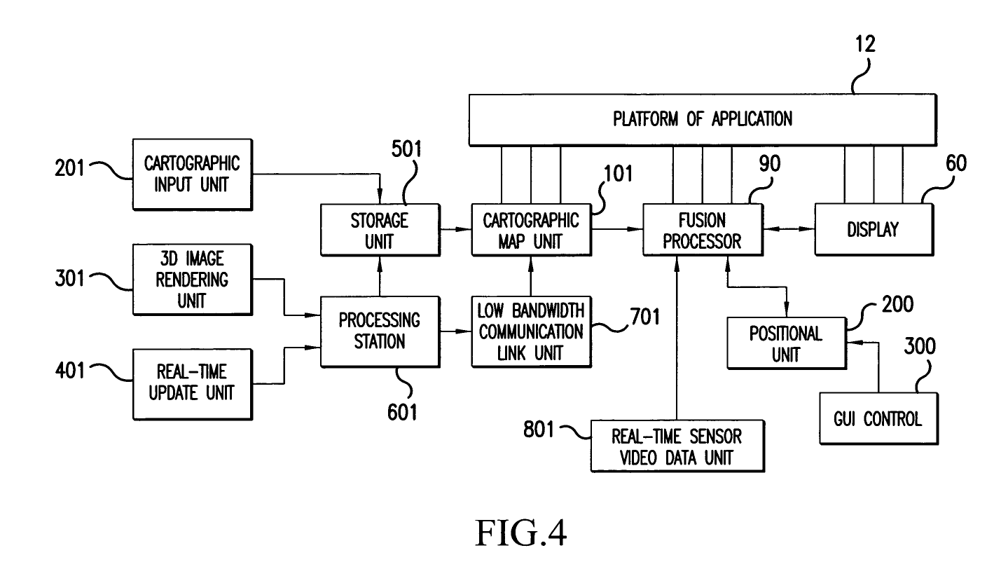

FIG. 4 shows a more detailed block diagram describing the functions performed in the perspective view imaging system 11 of FIG. 2. According to an embodiment of the present invention, the perspective view imaging system 11 may include a platform of application 12, a display 60, a fusion processor 90, a cartographic 3D map unit 101, a positional unit 200, a cartographic input unit 201, a GUI control 300, a 3D image rendering unit 301, a real-time update unit 401, a storage unit 501, a processing station 601, a low bandwidth communication link unit 701, and a real-time sensor video unit 801.

The platform of application 12, as shown in FIG. 4, may include, but is not limited to, a rotary wing aircraft, foot soldier, land combat ground vehicle, unmanned aerial vehicle (UAV), unmanned ground vehicle (UGV), high Altitude/high speed aircraft, low altitude/low speed aircraft, mission planning/rehearsal and post-mission debrief and battle damage assessment (BDA).

In accordance with an exemplary embodiment of the present invention, one end of the cartographic 3D map unit 101 is connected to an input line of the fusion processor 90 and the other end of the cartographic 3D map unit 101 is connected to an output line of the storage unit 501 and an output line of the low bandwidth communication link unit 701. The positional unit 200 and the real-time sensor video data unit 801 are both connected to other input lines of the fusion processor 90. The fusion processor 90 is connected to the display 60 and the positional unit 200 in a bi-directional fashion. GUI control 300 is connected to an input line of the positional unit 200. The processing station 601 is connected to an input line of the low bandwidth communication link unit 701 and an input line of the storage unit 501. The processing station 601 is also connected to an output line of the 3D image rendering unit 301 and an output line of the real-time image update unit 401. The cartographic input unit 201 is connected to a different input line of the storage unit 501.

According to an embodiment of the present invention, the cartographic input unit 201 shown in FIG. 4 receives position fused multiple imagery of a selected locale from multiple sources. This locale is typically from ten to one thousand miles square, but is not limited to these dimensions. Three dimensional resolution and position/location accuracy can vary from less than one foot to greater than fifty feet, depending on database sources available for the particular region being mapped. The sources for providing position fused multiple imagery can include, but are not limited to, satellite (SAT) visible and infrared image sources, airborne reconnaissance EO and IR image sources, Digital Terrain Elevation Data (DTED) data sources, and other photographic and image generation sources. Inputs from these various sources are received by the cartographic input unit 201 and formed into a composite digital database of the locale, which is stored in the storage unit 501.

The storage unit 501 may be a high capacity digital memory device, which may be periodically updated by data provided by the 3D image rendering unit 301 and real-time image update unit 401. The 3D image rendering unit 301 uses data from sources such as EO/IR/Laser Radar (LADAR)/Synthetic Aperture Radar (SAR) with special algorithms to render detailed 3D structures such as buildings and other man-made objects within the selected geographic locale. The real-time image update unit 401 also uses real-time updated data from sources such as EO/IR/Laser Radar (LADAR)/Synthetic Aperture Radar (SAR) of the selected geographic locale. Data provided by the 3D image rendering unit 301 and the real-time image update unit 401 is processed by the processing station 601 and outputs the processed update data to the storage unit 501 and the low bandwidth communication link unit 701. Outputs from the storage unit 501 and the low bandwidth communication link unit 701 are inputted to the cartographic 3D map unit 101 to generate a 3D cartographic map database of the selected geographical locale.

In an operational environment for the perspective view imaging system, sensors such as EO/IR/Laser Radar (LADAR)/Synthetic Aperture Radar (SAR) may be used at periodic intervals, e.g., hourly or daily, to provide periodic updates to the 3D cartographic map database via the processing station 601 which provides database enhancements. This 3D cartographic map database may be recorded and transported or transported via a high bandwidth digital data link to the platform of application 12 (e.g., rotary wing aircraft) where it may be stored in a high capacity compact digital memory (not shown). The database enhancements may also be compared with a database reference and advantageously only digital pixels (picture elements) may be transmitted to the 3D cartographic map database, which may be stored on the platform of application 12. This technique of change pixel detection and transmission, allows the use of a low bandwidth conventional military digital radio (e.g., SINGARS) to transmit this update of the stored 3D cartographic map database.

To place the platform of application 12 and a desired viewing perspective of an operator of the platform with respect to 3D cartographic map database, the fusion processor's 90 functions can vary from application to application but can include: correlation of multiple images from real-world real-time sensors and correlation of individual sensors or multiple sensors with the stored 3D cartographic map database; fusion of images among multiple imaging sensors; tracking of objects of interest within these sensor images; change detection of image areas from a given sensor or change detection among images from different sensors; applying navigation or route planning data to the stored 3D cartographic map database and sensor image data; adding threat or friendly force data such as Red Force/Blue Force tracking information as overlays into the stored map database; and adding on-platform mission planning/rehearsal routine symbology and routines to image data sequences.

Optionally, data received from the above-mentioned data sources may be translucently overlaid on the perspective view image provided by the perspective view data unit 92 as shown in FIGS. 2-3. Thus, the platform operator can advantageously identify each data with respective data source.

In accordance to an embodiment of the present invention, in addition to processing and fusing on-board and remote real-time sensor video and combining it with the stored 3D cartographic map database, the fusion processor 90 allows the platform 3D position information and its viewing perspective to determine the perspective view imaging perspective displayed to the platform operator on the display 60. As shown in FIG. 4, the positional unit 200 as described in the previous sections of this disclosure provides the 3D positional reference data to the fusion processor 90. This data may include a particular video stream related to the 3D position of the operator. The operator may then input a viewing perspective from which to observe the perspective view image by applying 6-DOF inputs from the GUI control 300 to provide a real-time video of the perspective view image.

The resulting perspective view imaging real-time video may be displayed on the display device 60. The display device 60 may be of various types depending on the platform of application 12 and mission requirements. The display device 60 may include, but is not limited to, a Cathode Ray Tubes (CRT), a flat-panel solid state display, a helmet mounted devices (HMD), and an optical projection heads-up displays (HUD). Thus, the platform operator obtains real-time video display available for his viewing within the selected geographic locale (e.g., a battlefield) which is a combination of the synthetic vision contained in the platform 3D cartographic map database fused with real-time EO or IR imaging video or superimposed with the real scene observed by the platform operator.

The real-time sensor video data unit 801 provides real-world real-time sensor data among on-board as well as remote sensors to the fusion processor 90. The fusion processor 90 fuses one or more of those sensor data with the 3D cartographic map database stored in the platform of application 12. In all of these fusion processes, the imagery may be of high definition quality (e.g., 1 mega pixel or greater) and may be real-time streaming video of at least 30 frames per second framing rate. In according to an embodiment of the present invention, this fusion technique is the process of attaching 3D spatial position as well as accurate time reference to each frame of each of these video streams. It is the process of correlating these video streams in time and space that allows the perspective view imaging process to operate successfully and to provide the operator real-time, fused, SynOptic Vision®.

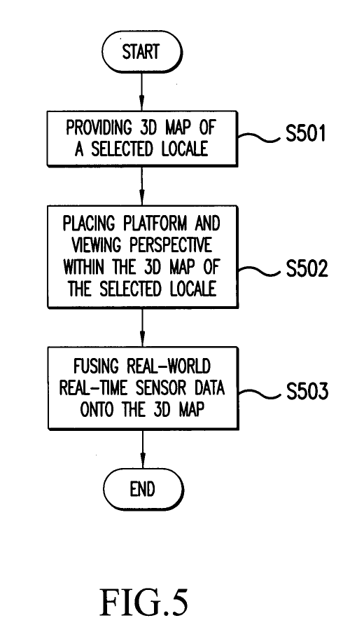

FIG. 5 is a flow diagram illustrating operations performed by a perspective view imaging system according to an embodiment of the present invention illustrated in FIG. 4. At step S501, a high-resolution 3D cartographic map database of a selected geographical locale is created by the cartographic 3D map unit 101 shown in FIG. 4. At step S502, a platform and a desired viewing perspective of an operator with respect to the 3D cartographic map database of the selected locale is placed. At step S503, real-world real-time sensor data among on-board as well as remote sensors onto the 3D cartographic map database is fused. This real-time real-world data may include geo-location data. This geo-location data may include, but is not limited to Red Force/Blue Force tracking data, radar or laser altimeter data, EO/IR imaging sensor data, moving target indicator (MTI) data, synthetic aperture radar (SAR) data, inverse synthetic aperture data (ISAR) data, laser/LADAR imaging data. Thus, adding geo-location data to individual video frames may allow referencing each sensor data with respect to the other imaging sensors and to the 3D cartographic database map created by the 3D cartographic map unit 101. This data as a whole may be referred to as metadata set to achieve the perspective view image.

In order to provide the metadata for this 3D cartographic application, the metadata may be synchronized with the imagery or RF data that will be fused with the 3D cartographic map database. Two methods may be used for adding the necessary metadata to ensure synchronization.

The first is digital video frame based insertion of metadata that uses video lines within each frame that are outside a displayable field. The metadata is encoded in pixel values that are received and decoded by the 3D ingestion algorithm. The 3D ingestion algorithm performs the referencing function mentioned earlier. This algorithm utilizes values in the metadata payload to process the image into an ingestible form by the visual application for display on the display 60.

The second method accommodates remotely transmitted data that typically arrives in a compressed format. For this application, an elementary stream of metadata that is multiplexed with the video transport stream discussed above. Time stamp synchronization authored by the sending platform is utilized for this method. Prior to the data being routed to an image or data decoder (not shown), the 3D ingestion algorithm identifies and separates the elementary stream from the transmission and creates a linked database of the metadata to the data files as they are passed through decode operation.

The map is rendered in a manner that permits the operator to operate in the 3D environment as one would with a typical imaging sensor. Scan rates, aspect ratios, and output formats are matched to that of imaging sensors to provide natural interfaces to display 60 used in a various stated platform applications.

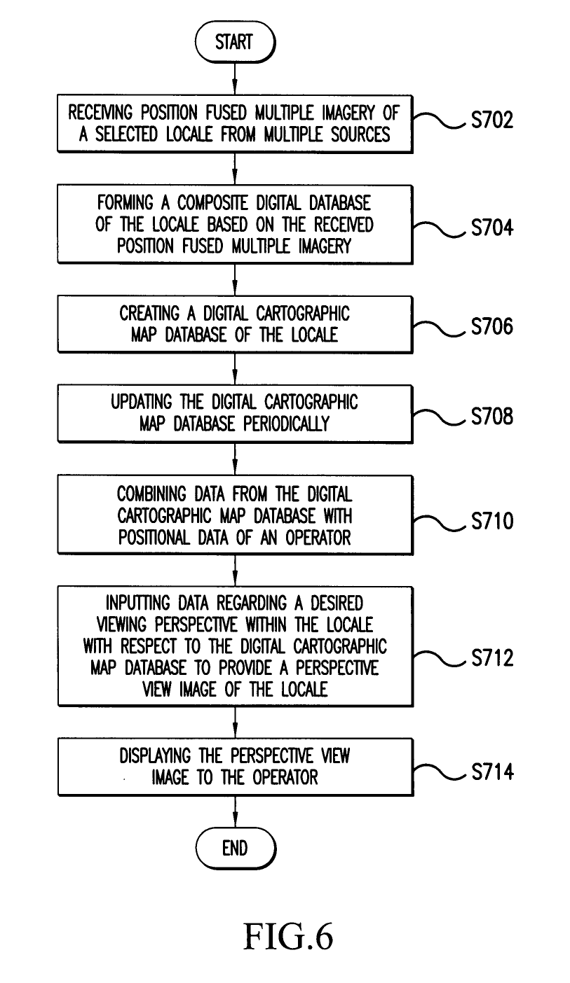

FIG. 6 shows a more detailed flow diagram illustrating operations performed by the perspective view imaging system according to an embodiment of the present invention illustrated in FIG. 4. At step S702, the cartographic input unit 201 receives position fused multiple imagery of a selected locale from multiple sources. At step S704, the cartographic 3D map unit 101 forms a composite digital database of the locale based on the received position fused multiple imagery and processed data from the 3D image rendering unit 301 and real-time image update unit 401 via low bandwidth communication link unit 701. At step S706, the cartographic 3D map unit created a digital cartographic map database of the locale. The map database may include 3D map data. At step S708, the digital cartographic map database is periodically updated based on data received from the real-time image update unit 401. At step S710, the fusion processor 90 combines data from the digital cartographic map database with positional data of a platform operator and real-time real-world geo-location data provided by the real-time sensor video data unit 801. At S712, the platform operator inputs data regarding a desired viewing perspective within the locale with respect to the digital cartographic map database to provide a perspective view image of the locale. At step S714, the perspective view image is displayed on the display 60.

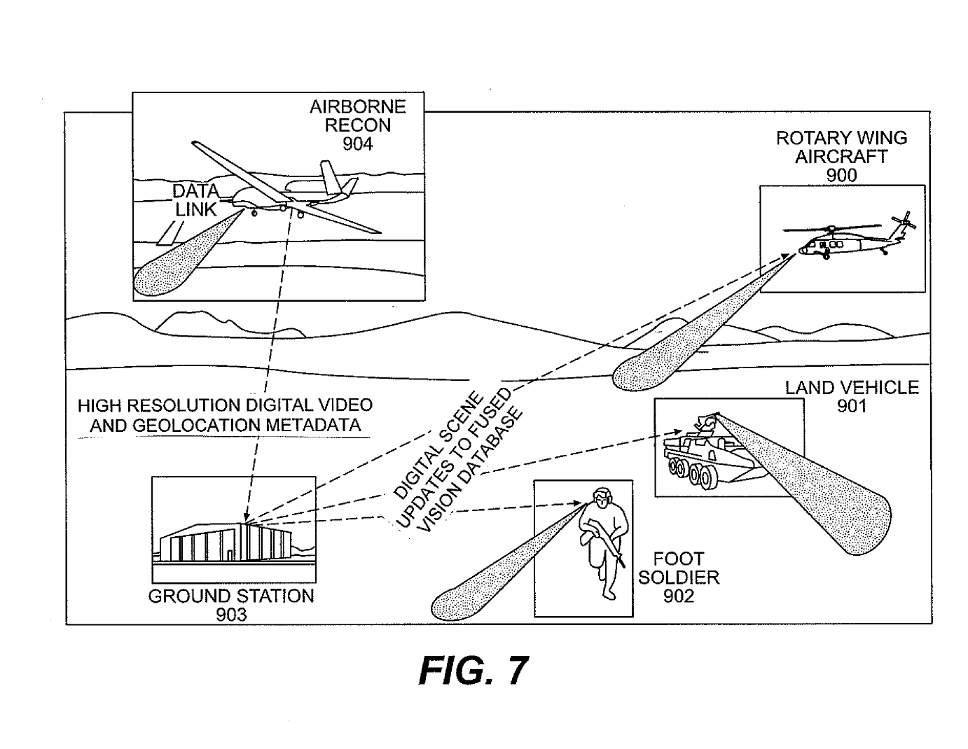

FIG. 7 shows a general method by which perspective view imaging may be employed by three different illustrative platform operators, all using the same concept as described above but with three different hardware embodiments as dictated by the platform constraints and detailed operational uses.

As shown in FIG. 7, the perspective view imaging is being used by a rotary wing pilot or gunner operating a rotary wing aircraft 900, an armored vehicle driver or commander operating an armored vehicle 901, and an infantry armored foot soldier 902. Each of these platforms is operating in the same general geographic area and, therefore, has on-board their platform or their person the 3D cartographic database map stored in the cartographic 3D map unit 101 shown in FIG. 4, which has been assembled from a variety of digital data sources as described in the previous sections. In operation, an airborne recon 904 may include high performance sensor (not shown) to provide a data link and sends high-resolution digital video and geo-location metadata to a ground station 903. The ground station 903 transmits scene change data to the pilot or gunner operating the rotary wing aircraft 900, the armored vehicle driver or commander operating the armored vehicle 901, and the infantry armored foot soldier 902.

Each of these three platform operators, however, sees a different part of the stored map and can select his viewing perspective as the tactical need arises. The platform operator's viewing perspective of the map can be steered around the platform and appears to see through the platform in any direction. It may be fused with real-world real-time EO or IR or 12R data provided by the real-time sensor video data unit 801 shown in FIG. 4, as visibility permits. It may also be fused or superimposed over the platform operator's natural eye vision as exemplified in FIG. 7 for the foot soldier 902. The perspective view image that the operator obtains from a synthetic database created by combining data from the synthetic vision unit 70 and the geo-located video unit 80 as shown in FIG. 2 does not depend on either natural light or infrared radiation and is unaffected by obscurants, rain, snow, or clouds. It does, however, advantageously show the synthetic view as last recorded on the digital 3D cartographic map database created by the cartographic 3D map unit 101 shown in FIG. 4. It is the fusion of the real-world, real-time sensor data provided by the real-time image update unit 401 shown in FIG. 4, which updates this digital 3D cartographic map database for recent change or movement in the scene. As described in the previous sections, digital scene updates to a SynOptic Vision® database on the platform of interest may be provided as low bandwidth change data using the low bandwidth communication link unit 701 shown in FIG. 4 (e.g., conventional military radio channels). This technique allows frequent updates to the database in the area of interest without the need for independent high performance sensors on the platforms and independent of inclement weather and obscurants.

The 3D cartography map database created by the 3D cartographic map unit 101 shown in FIG. 4 may be utilized to provide tactical situational awareness, navigation and pilotage capabilities through 6DOF location awareness inputs and 6DOF steering inputs as described above. Tactical situational awareness designates data that is required for an operator to more effectively perform their task in a combative environment. Effectiveness is achieved by providing a visual representation of the knowledge that is contained in the area of operation for the particular operator. Knowledge is defined in this architecture as consisting of position data of other forces both friend and foe; visual annotations that can include real-time or past reports in text format, voice records, or movie clips that are geo-specific; command and control elements at tactical levels including current tasking of elements, priority of mission, and operational assets that are available for tactical support.

In accordance to an embodiment of the present invention, the method for achieving tactical situational awareness may be through the creation of a tailored environment specific to each operator that defines the data necessary to drive effectiveness into the specific mission. The map implementation can meet pre-determined operational profiles or be tailored by each operator to provide only the data that is operationally useful. However, even in the scenario when functions are disabled, the operator has the option to engage a service function that will provide alerts for review while not actively displaying all data available on the display 60.

In accordance to a further embodiment of the present invention, friendly forces are tracked in two manners: immediate area and tactical area. Immediate area tracking is applicable to dismounted foot soldier applications where a group of operators have disembarked a vehicle. This is achieved by each soldier being equipped with a GPS Receiver that is integrated with a man-portable CPU and communications link. Position data is reported at periodic intervals to the vehicle by each operator over a wireless communications link. The vehicle hardware receives the reports and in its own application assembles the data into a tactical operational picture.

Tactical area tracking is achieved by each element in a pre-determined operational zone interacting with a Tactical Situational Awareness Registry (not shown). This registry may serve as the knowledge database for the display 60. For data that is not contained or available locally by the operator, the Tactical Situational Awareness Registry can provide the data or provide a communications path to acquire the data as requested by the operator's profile. As mentioned earlier, this data may include still or motion imagery available in compressed or raw formats, text files-created through voice recognition methods, or manual input and command/control data. Data is intelligently transferred in that a priori knowledge of the data-link throughput capacity and reliability is factored into the profiles of each element that interacts with the registry. The intelligent transfer may include bit rate control, error correction and data redundancy methods to ensure delivery of the data. As a result of being able to isolate the change-data, operation within very constrained communication networks is possible. The registry maintains configuration control of the underlying imagery database on each entity and has the capacity to refer only approved, updated imagery files to the operator while updating the configuration state in the registry.

In accordance to a further embodiment of the present invention, the 3D cartography map database created by the cartographic 3D map unit 101 shown in FIG. 4 may also be utilized in a navigation/pilotage application. The method for utilizing the 3D cartography map database may consist of two embodiments: airborne and ground. For this section, an entity is defined as the vehicle that physically exists (i.e. the rotorcraft, the vehicle etc). As previously disclosed, the method of rendering of the 3D map is designed to provide a common appearance and operational capability between optically based navigation sensors and a 3D map utility. For both airborne and ground applications, the required integration with a vehicular navigation system (not shown) is the same. The 3D map utility is integrated with the vehicle navigation system to allow entity control within a 3D environment. Latitude, Longitude, Altitude position data and Pitch, Roll and Yaw angular rate and angle data may be the required elements to achieve such entity control. This data is received by the platform application 12 shown in FIG. 4 at a maximum rate that a navigation sensor can provide. In the event that the navigation data is below the frame update rate of the display 60 shown in FIG. 4, data smoothing functions may be implemented to guarantee frame-to-frame control for 3D application. This allows for a smooth drive-thru or fly-through operator interface that is representative of an optically based sensor described earlier. For operator interaction, this method has implemented both manual input control as well as head tracked control as disclosed earlier. Manual control may be achieved by joystick/handgrip control common with the optically based navigation sensor. Head tracked control is achieved by the secondary integration of the head position as ‘eye-point’ control in addition to the entity control.

According to a further embodiment of the present invention, the 3D cartographic map database created by the 3D cartographic map unit 101 shown in FIG. 4 may also be utilized to provide a 3D cartographic framework for scaleable and various degrees of multi-sensor fusion with two-dimensional (2D) and 3D RF and EO imaging sensors and other intelligence sources disclosed previously. In an exemplary embodiment, this 3D cartographic framework may be able to consume multiple sources of sensor data through an application interface (not shown). The framework designates a set of metadata, or descriptive data, which accompanies imagery, RF data, or intelligence files which may serve to provide a conduit into visual applications.

In a map-based application, position and rate data for entity control are the driving components for merging auxiliary sources of data into a 3D visualization. However, accurate and reliable fusion of data may require pedigree, a measure of quality, sensor models that aid in providing correction factors and other data that aids in deconfliction (a systematic management procedure to coordinate the use of the electromagnetic spectrum for operations, communications, and intelligence functions), operator's desire and mission description.

The 3D cartographic framework may be designed to accept still and motion imagery in multiple color bands, which can be orthorectified (a process by which the geometric distortions of an image are modeled and accounted for, resulting in a planimetricly correct image), geolocated and visually placed within the 3D application in a replacement or overlay fashion to the underlying image database. RF data including LADAR and SAR disclosed previously may be ingested into the 3D application as well. Important to this feature is that 6DOF operation of both the entity and the operator is maintained with ingested data from multiple sensors as disclosed earlier. This allows the operation within the 3D cartographic map database independent of the position of the sensor that is providing the data being fused.

In accordance with an embodiment of the present invention, high-end 2D and 3D RF, imaging and other sensor data as disclosed previously may be utilized as truth source for difference detection against the 3D cartographic database map created by the 3D cartographic map unit 101.

The 3D cartographic database map may be recognized as being temporally irrelevant in a tactical environment. While suitable for mission planning and rehearsal, imagery that is hours old in a rapidly changing environment could prove to be unusable. Thus, high quality 2D and 3D RF, imaging and other sensors can provide real-time or near real time truth to the dated 3D cartographic database map created by the 3D cartographic map unit 101. A method for implementing of this feature may involve a priori knowledge of the observing sensors parameters that creates a metadata set. In addition, entity location and eye point data are also required. This data is passed to the 3D cartographic application that emulates the sensor's observation state. The 3D application records a snapshot of the scene that was driven by the live sensor and applies sensor parameters to it to match unique performance characteristics that are applicable to a live image. The two images are then passed to a correlation function that operates in a bi-directional fashion as shown in FIG. 4. Differences or changes that are present in the current data are passed back to the 3D visual application for potential consumption by the database. Differences or Changes that are present in the 3D visual application are passed back to the live data and highlighted in a manner suitable to the type of data. It is important in this bi-directional capability that the geo-location accuracy of the 3D visual application will likely be superior to the geo-location capability of an observing sensor. As the sensor's observation state is a creation of an aircraft navigation system with its inherent inaccuracies, the present invention may be able to resolve these inaccuracies of the platform geo-location and sensor observation state through a correlation function performed by the 3D visual application.

In accordance with a further embodiment of the present invention, the 3D digital cartographic map database created by the 3D cartographic map unit 101 shown in FIG. 4 may also be seamlessly translated from mission planning/rehearsal simulation into tactical real-time platform and mission environment.

In the mission planning/rehearsal simulation environment, a typical view is a global familiarization with the operational environment to provide visual cues, features, and large-scale elements to the operator exclusive of the lower level tactical data that will be useful during the actual mission or exercise. In order to provide a seamless transition from the simulation environment to the mission environment, pre-defined or customizable operator profiles may be created that are selected by the operator either at the conclusion of the simulation session or during the mission. The application profile, the underlying image database, configuration state is contained on a portable solid-state storage device (not shown) that may be carried from the simulation rehearsal environment to the mission environment. The application script that resides on a CPU polls a portable device (not shown) upon boot and loads an appropriate mission scenario.

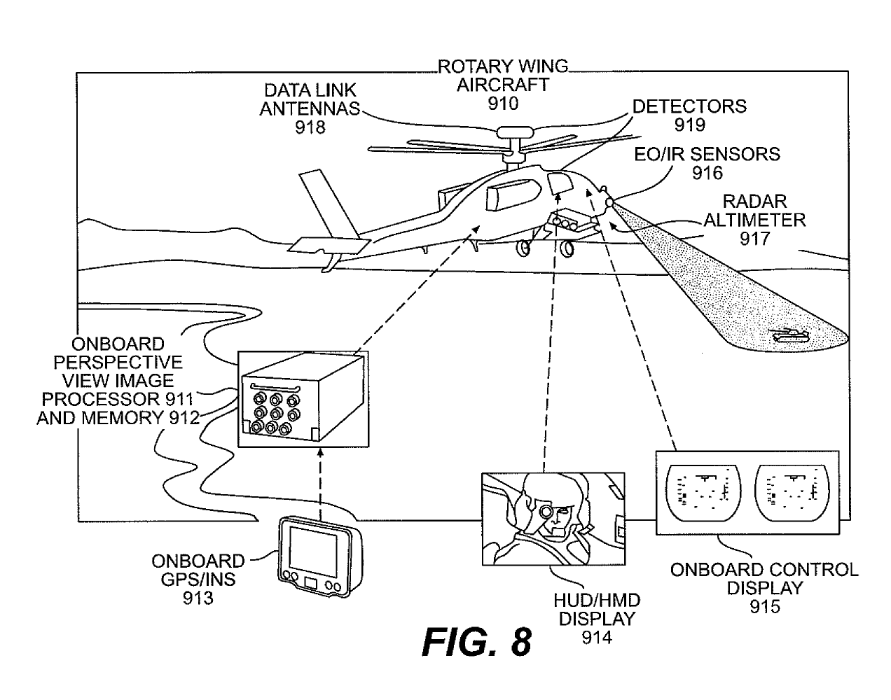

FIG. 8 shows an exemplary application of perspective view imaging to a rotary wing aircraft 910 in accordance to an embodiment of the present invention. The rotary wing aircraft 910 includes an onboard perspective view image processor 911 and a memory 912, an on board GPS/INS 913, a heads-up/head-mounted (HUD/HMD) display 914 for the operator of the rotary wing aircraft 910, an onboard control/display 915 (e.g., a cockpit display), EO/IR sensors 916, a radar altimeter 917, a data link antenna 918 and detectors 919. Detectors 919 may include, but are not limited to, radar (RAD), radar frequency interferometer (RFI), and passive RF/IRCM detectors.

The actual implementation of perspective view imaging for the rotary wing aircraft 910 may be as varied as the missions performed. In its simplest form, the on-platform 3D digital cartographic map database created by the 3D cartographic map unit 101 shown in FIG. 4 is fused with the positional data provided by the onboard GPS/INS 913 and radar data provided by radar altimeter 916 in the perspective view image processor 911, and displayed on the display 915. Advantageously, this provides the operator of the rotary wing aircraft 910 having no EO Sensor with a “daylight-out the window” view to aid in all tasks which benefit from improved situational awareness (SA). Referencing the 3D digital cartographic database to the radar altimeter 917 may be necessary to allow safe takeoff and landing type maneuvers in “brown-out” conditions such as those caused by rotor-wash in desert terrain. In this configuration the on-platform database can receive updates via existing low-bandwidth tactical radios. More complex configurations will use the 3D database as the framework onto which other sources are fused. Sources may include but are not limited to the EO/IR/Laser sensors 916 and detectors 917 (e.g., Radar, RFI, and passive RF/IRCM sensors), both on and off platform, as well as other intelligence sources such as Red Force/Blue Force symbology. Using the HUD/HMD display 914 may improve SA for pilotage and survivability. By fusing all the above-mentioned sensors using the perspective view image processor 911 results into a single unified display thereby reducing the operator's workload. Aircraft with high-end sensors such as the airborne recon 904 shown in FIG. 7 may additionally serve as sources, supplying current data to the ground station 903 shown in FIG. 7 for change detection against the currently fielded 3D cartographic database via high-bandwidth RF links or a digital flight recorder (not shown).

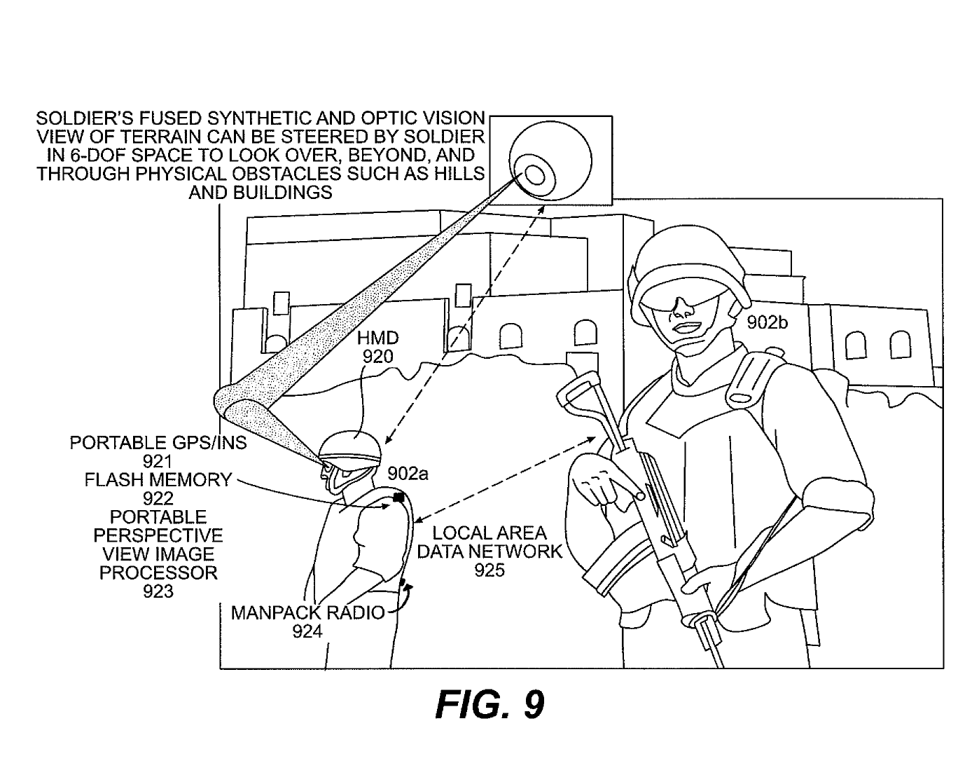

FIG. 9 shows an exemplary application of perspective view imaging to a foot soldier 902a in accordance to an embodiment of the present invention. For the foot soldier 902a, perspective view imaging provides improved SA and efficiency by displaying the 3D cartographic map data via an HMD 920. In this exemplary application, the soldier 902a carries a portable GPS/INS 921, a flash memory 922 that stores local terrain 3D cartographic database and a portable perspective view image processor 923 similar in configuration of the onboard perspective view image processor 911 shown in FIG. 8. The location and point of view of the soldier 902a are determined via the portable GPS/INS 921 and helmet sensors (not shown). The 3D data is presented to the soldier 902a to supplement the soldier's own vision and image-intensified night vision or infrared night vision device, if present. Updates to the 3D data, as well as other intelligence such as Red Force/Blue Force data are received as needed via conventional man-pack radio 924. The man-pack radio 924 may include by not limited to man-pack VHF/UHF radio receivers. The perspective view imaging not only improves current SA, but also allows the soldier 902a to “look ahead” beyond obstacles or line-of-sight, for real-time planning and sharing this synthetic and perspective view image with other soldiers 902b via a local area network 925 (e.g., a WiFi 802.11B network), or other local wireless data networks.

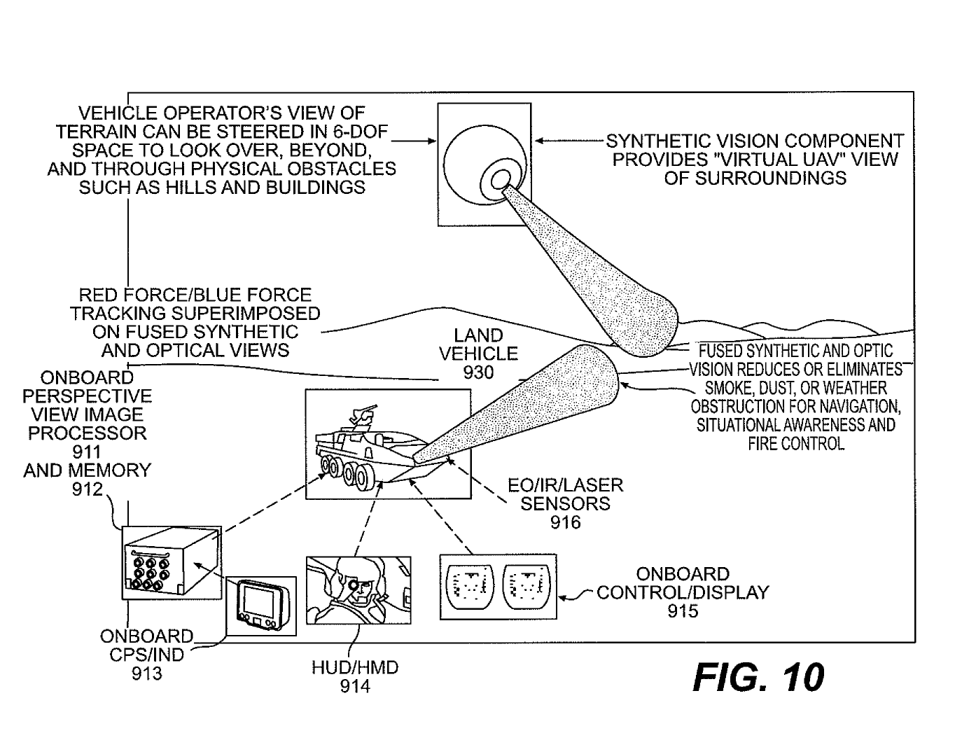

FIG. 10 shows an exemplary application of perspective view imaging to an operator of a land vehicle 930 in accordance to an embodiment of the present invention. The land vehicle 930 also includes an onboard perspective view image processor 911 and a memory 912, an on board GPS/INS 913, a HUD/HMD display 914 for the operator of the land vehicle 930, an onboard control/display 915, and EO/IR/Laser sensors 916. For the land vehicle operator, perspective view imaging combines the benefits previously described for operator of the rotary wing aircraft 910 with those offered to the foot soldier 902a. The 3D cartographic map database created by the 3D cartographic map unit 101 shown in FIG. 4 presented to the operator of the land vehicle 930 improves SA during any situation causing poor visibility including smoke, dust, inclement weather, or line of sight obscuration due to terrain or buildings. It may also serve as a framework into which other data can be fused to present a unified display to the operator of the land vehicle 930, including EO/IR, LADAR, and Radar sensors, as well as other data available via radio such as Red Force/Blue Force data as previously disclosed. As with the foot soldier 902a, the operator of the land vehicle 930 can project his point of view to any location or altitude of interest like a “Virtual UAV”, providing SA beyond his on-board sensors line-of-sight.

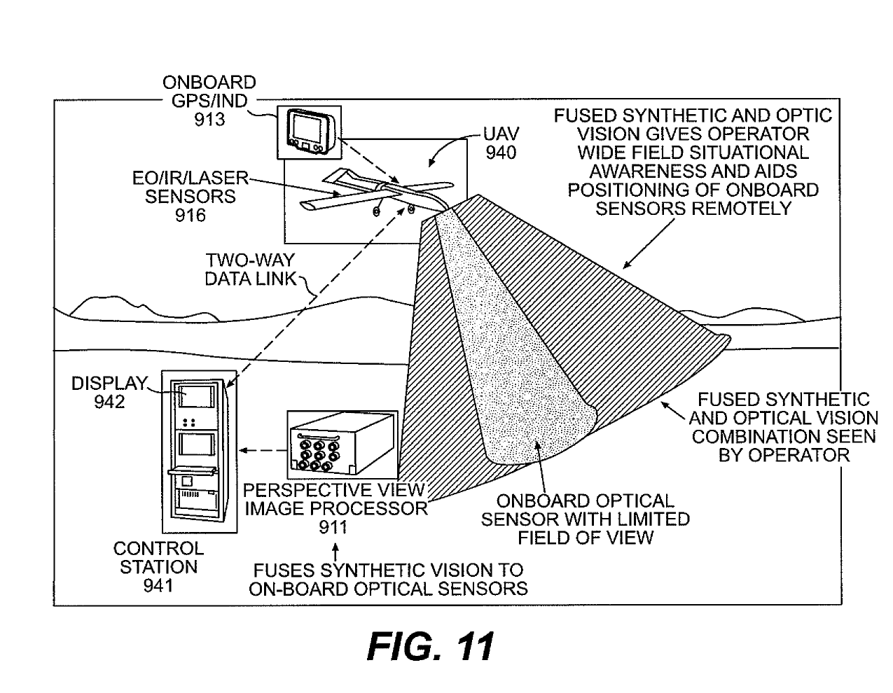

FIG. 11 shows an exemplary application of perspective view imaging to an operator of an UAV 940 in accordance to an embodiment of the present invention. The UAV 940 may include onboard GPS/INS 913 and EO/IR/Laser sensors 916. In this exemplary embodiment, a perspective view image processor 911 provides perspective view imaging to an operator of a remote control station 941. The operator of the remote control station 941 controls the UAV 940 via a two-way data link described in the previous sections. Currently, UAV operators are hindered by limited SA due to a lack of an “out the window” perspective, and the narrow field-of-view (FOV) presented by narrow FOV UAV sensors (not shown). Perspective view imaging provided by the perspective view image processor 911 improves SA by providing the operator of the UAV 940 with an unlimited FOV from the perspective of the UAV 940 using the onboard GPS/INS 913. The narrow FOV sensors are then referenced and the narrow FOV data provided by the narrow FOV sensors are fused within a wide FOV with an added benefit of additional intelligence data (e.g., Red Force/Blue Force data disclosed in the previous sections), overlaid on a display 942 of the control station 941, thereby aiding the operator of the UAV 940 to position the narrow-FOV sensors to execute a given mission with an enhanced accuracy.

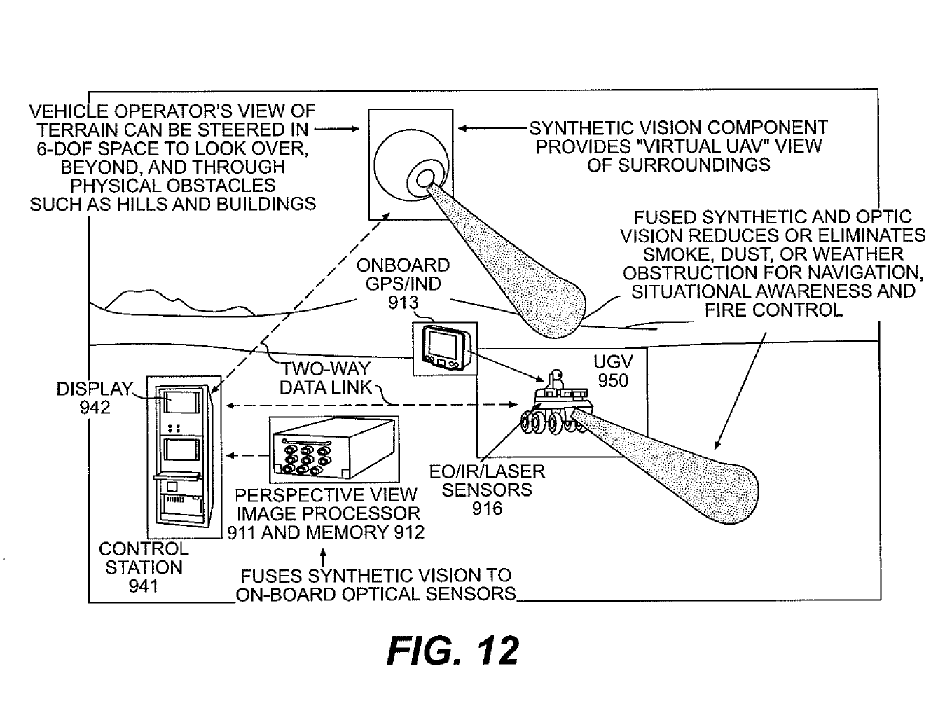

FIG. 12 shows an exemplary application of perspective view imaging to an operator of an UGV 950 in according to an embodiment of the present invention. Similar to the UAV 940, the UGV may also include an onboard GPS/INS 913 and EO/IR/Laser sensors 916. In this exemplary embodiment, the perspective view image processor 911 provides perspective view imaging to an operator of the remote control station 941. The operator of the remote control station 941 controls the UGV 950 via a two-way data link described in the previous section. Currently, the UGV operators are hindered by the line-of-sight (LOS) limitations of an operator of a conventional land vehicle, combined with the narrow FOV of onboard sensors (not shown) much like the operators of a conventional UAV. Perspective view imaging improves SA by providing the operator of the UGV 950 with an unlimited FOV from the perspective of the UGV 950 using the onboard GPS/INS 913. The onboard sensors 916 of the UGV 950 are referenced and fused within the wide FOV provided by the 3D cartographic data stored in the operator's control station 941, providing the operator with improved SA for maneuvering and navigation with an added benefit of additional intelligence data (e.g., Red Force/Blue Force data disclosed in the previous sections), overlaid on a display 942 of the control station 941. Additionally the operator of the UGV benefits from the same “Virtual UAV” as the operator of the land vehicle 930, by providing SA beyond LOS for real-time mission changes.

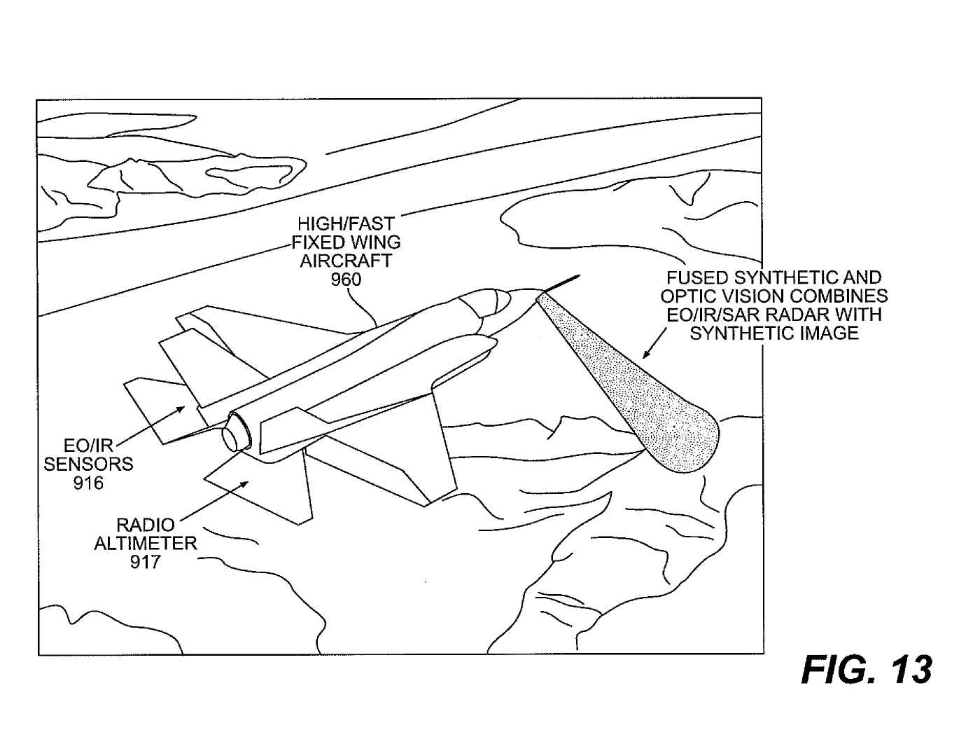

FIG. 13 shows an exemplary application of perspective view imaging to an operator of a high/fast fixed wing aircraft 960 in according to an embodiment of the present invention. For this application, perspective view imaging again uses the onboard 3D cartographic database created by the 3D cartographic map unit 101 shown in FIG. 4 as a framework to which other sensors and data previously disclosed are fused. EO/IR, Radar, ECM data, and off platform intelligence such as Red Force/Blue Force data are presented in a single unified interface to the operator of the high/fast fixed wing aircraft 960, thereby improving SA and reducing workload for the operator. Additionally, perspective view imaging enables more rapid target acquisition by onboard sensors (not shown) when dropping through a cloud deck.

Perspective view imaging may also be applied to a pilot and crew of a low altitude fixed wing aircraft (not shown) in a similar fashion as described previously for the rotary wing aircraft 910. Thus, perspective view imaging benefits provided to the pilot and crew of the low altitude fixed wing aircraft are very similar to the benefits previously described for the rotary wing flight crew.

Additionally, as described in the text for FIG. 8, any platform which has high-end EO/IR sensors will serve as a source, supplying current data to the ground station 941 for change detection against the currently stored 3D database via high-bandwidth RF links or a digital flight recorder. Changes detected will then be forwarded to all fielded systems as needed via existing low-bandwidth RF communication links for near real-time updates to their local 3D cartographic database.

The invention is particularly suitable for implementation by a computer program stored on a computer-readable medium comprising program code means adapted to perform the steps of the method for providing a perspective view image created by fusing a plurality of sensor data for supply to an operator with a desired viewing perspective within an area of operation, wherein the area of operation includes a battlefield, the computer program when executed causes a processor to execute steps of: providing a plurality of sensors configured to provide substantially real-time data of the area of operation, combining the substantially real-time data of the area of operation with digital terrain elevation data of the area of operation and positional data of the operator to create a digital cartographic map database having substantially real-real time sensor data, inputting data regarding the desired viewing perspective within the area of operation with respect to the digital cartographic map database to provide a perspective view image of the area of operation, and displaying the perspective view image to the operator.

The computer program, when executed, can cause the processor to further execute steps of: receiving updated positional data regarding the operator's current position, and updating the cartographic map database to reflect the operator's current position based on the updated positional data.

The computer program, when executed, can cause the processor to further execute steps of: receiving updated perspective view data from the operator through six-degree-of-freedom steering inputs, and updating the displayed perspective view image in accordance with the received updated perspective view data.

For further enhancing the computer program, an embodiment is provided wherein the plurality sensors includes one or more of the following image sensors: electro-optical (EO) image sensor, infrared (IR) image sensor, intensified or low-light level image sensor, radar three dimensional image sensor, or range data image sensor. The sensor data can include compressed still or motion imagery. The sensor data can include raw still or motion imagery.

The computer program, when executed, can cause the processor to further execute step of: displaying the perspective view image on one of the following display devices: Cathode Ray Tubes (CRT), flat-panel solid state display, helmet mounted devices (HMD), and optical projection heads-up displays (HUD).

The computer program, when executed, can cause the processor to further execute steps of: creating a remote Tactical Situational Awareness Registry (TSAR) for storing situational awareness data obtained through six-degree-of-freedom location awareness inputs, and providing the situational awareness data to the operator that is not contained or available locally by the operator.

The computer program, when executed, can cause the processor to further execute step of: providing a communication path to the operator to acquire the situational awareness data requested by the operator based on a profile of the operator. The computer program, when executed, can cause the processor to further execute step of: creating a three-dimensional digital cartographic map database of the area of operation.

The computer program, when executed, can cause the processor to further execute steps of: receiving a plurality of imagery through an application interface, wherein the imagery includes still and motion imagery in multiple color bands or wavelengths, and designating a set of metadata corresponding to the plurality of imagery for providing a path into a visual application including the digital cartographic map database. The computer program, when executed, can cause the processor to further execute step of: synchronizing the set of metadata with the plurality of imagery.

The computer program, when executed, can cause the processor to further execute steps of: utilizing the digital cartographic map database to provide a framework for scalable and various degrees of multi-sensor fusion with two-dimensional and three-dimensional RF and EO imaging sensors and other intelligence sources.

The computer program, when executed, can cause the processor to further execute steps of: adding geo-location data to individual video frames to allow referencing each sensor data with respect to the other imaging sensors and to the digital cartographic map database.

The computer program, when executed, can cause the processor to further execute step of: utilizing two-dimensional and three-dimensional RF, imaging and other sensor data as truth source for difference detection against the digital cartographic map database.

The computer program, when executed, can cause the processor to further execute step of: seamlessly translating the digital cartographic map data stored on the digital cartographic map database from mission planning/rehearsal simulation into tactical real-time platform and mission environment.

Although the invention is primarily described herein using particular embodiments, it will be appreciated by those skilled in the art that modifications and changes may be made without departing from the scope of the present invention. As such, the method disclosed herein is not limited to what has been particularly shown and described herein, but rather the scope of the present invention is defined only by the appended claims.

What is claimed is:

1. A method for providing a perspective view image created by fusing a plurality of sensor data for supply to an operator with a desired viewing perspective within an area of operation, wherein the area of operation includes a battlefield, comprising:
providing a plurality of sensors configured to provide substantially real-time data of the area of operation;
combining the substantially real-time data of the area of operation with digital terrain elevation data of the area of operation and positional data of the operator to create a digital cartographic map database having substantially real-real time sensor data;
inputting data regarding the desired viewing perspective within the area of operation with respect to the digital cartographic map database to provide a perspective view image of the area of operation; and
displaying the perspective view image to the operator.

2. The method of claim 1, further comprising:
receiving updated positional data regarding the operator's current position; and
updating the cartographic map database to reflect the operator's current position based on the updated positional data.

3. The method of claim 1, further comprising:
receiving updated perspective view data through six-degree-of-freedom steering inputs from the operator, either from manual or head-steered commands; and
updating the displayed perspective view image in accordance with the received updated perspective view data.

4. The method of claim 1, wherein the plurality sensors includes one or more of the following image sensors: electro-optical (EO) image sensor, infrared (IR) image sensor, intensified or low-light level image sensor, radar three dimensional image sensor, or range data image sensor, or human eye.

5. The method of claim 4, wherein sensor data includes compressed still or motion imagery.

6. The method of claim 4, wherein sensor data includes raw still or motion imagery.

7. The method of claim 1, further comprising displaying the perspective view image on one of the following display devices: Cathode Ray Tubes (CRT), flat-panel solid state display, helmet mounted devices (HMD), and optical projection heads-up displays (HUD).

8. The method of claim 1, further comprising:
creating a remote Tactical Situational Awareness Registry (TSAR) for storing situational awareness data obtained through six-degree-of-freedom location awareness inputs;
and providing the situational awareness data to the operator that is not contained or available locally by the operator.

9. The method of claim 8, further comprising: providing a communication path to the operator to acquire the situational awareness data requested by the operator based on a profile of the operator.

10. The method of claim 1, further comprising: creating a three-dimensional digital cartographic map database of the area of operation.

11. The method of claim 1, further comprising: receiving a plurality of imagery through an application interface, wherein the imagery includes still and motion imagery in multiple color bands or wavelengths; and
designating a set of metadata corresponding to the plurality of imagery for providing a path into a visual application including the digital cartographic map database.

12. The method of claim 11, further comprising: synchronizing the set of metadata with the plurality of imagery.

13. The method of claim 1, further comprising: utilizing the digital cartographic map database to provide a framework for scalable and various degrees of multi-sensor fusion with two-dimensional and three-dimensional RF and EO imaging sensors and other intelligence sources.

14. The method of claim 13, further comprising: adding geo-location data to individual video frames to allow referencing each sensor data with respect to the other imaging sensors and to the digital cartographic map database.

15. The method of claim 1, further comprising: utilizing two-dimensional and three-dimensional RF, imaging and other sensor data as truth source for difference detection against the digital cartographic map database.

16. The method of claim 1, further comprising: seamlessly translating the digital cartographic map data stored on the digital cartographic map database from mission planning/rehearsal simulation into tactical real-time platform and mission environment.

17. A system for providing a perspective view image created by fusing a plurality of sensor data for supply to an operator with a desired viewing perspective within an area of operation, wherein the area of operation includes a battlefield, comprising:
a receiver for receiving a plurality of substantially real-time sensor data of the area of operation from a plurality of sensors;
a processor for combining the substantially real-time sensor data of the area of operation with digital terrain elevation data of the area of operation and positional data of the operator to create a digital cartographic map database having substantially real-real time sensor data;
a perspective view data unit for inputting data regarding the desired viewing perspective within the area of operation with respect to the digital cartographic map database to provide a perspective view image of the area of operation; and
a display for displaying the perspective view image to the operator.

18. The system of claim 17, wherein the receiver receives updated positional data regarding the operator's current position in order to update the cartographic map database to reflect the operator's current position based on the updated positional data.

19. The system of claim 17, wherein the receiver receives updated perspective view data from the operator through six-degree-of-freedom steering inputs either from manual or head-steered commands; in order to update the displayed perspective view image in accordance with the received updated perspective view data.

20. The system of claim 17, wherein the plurality sensors includes one or more of the following image sensors: electro-optical (EO) image sensor, infrared (IR) image sensor, intensified or low-light level image sensor, radar three dimensional image sensor, or range data image sensor or human eye.

21. The system of claim 20, wherein the sensor data includes compressed still or motion imagery.

22. The system of claim 20, wherein the sensor data includes raw still or motion imagery.

23. The system of claim 17, wherein the display includes one or more of the following devices: Cathode Ray Tubes (CRT), flat-panel solid state display, helmet mounted devices (HMD), and optical projection heads-up displays (HUD).

24. The system of claim 17, further comprising:
a registry for storing remote tactical situational awareness data obtained through six-degree-of-freedom location awareness inputs wherein the display displays the situational awareness data to the operator that is not contained or available locally by the operator.

25. The system of claim 17, wherein the digital cartographic map database includes three-dimensional digital cartographic map data of the area of operation.

26. The system of claim 17, further comprising:
an application interface for receiving a plurality of imagery, wherein the imagery includes still and motion imagery in multiple color bands or wavelengths; and
a set of metadata corresponding to the plurality of imagery for providing a path into a visual application including the digital cartographic map database.

27. The system of claim 26, wherein the set of metadata is synchronized with the plurality of imagery.

28. The system of claim 17, wherein the digital cartographic map database is utilized to provide a framework for scalable and various degrees of multi-sensor fusion with two-dimensional and three-dimensional RF and EO imaging sensors and other intelligence sources.

29. The system of claim 28, wherein geo-location data is added to individual video frames to allow referencing each sensor data with respect to the other imaging sensors and to the digital cartographic map database.

30. The system of claim 17, further comprising: utilizing two-dimensional and three-dimensional RF, imaging and other sensor data as truth source for difference detection against the digital cartographic map database.

31. The system of claim 17, wherein the digital cartographic map data stored on the digital cartographic map database is seamlessly translated from mission planning/rehearsal simulation into tactical substantially real-time platform and mission environment.

32. A computer readable storage medium having stored thereon computer executable program for providing a perspective view image created by fusing a plurality of sensor data for supply to an operator with a desired viewing perspective within an area of operation, wherein the area of operation includes a battlefield, the computer program when executed causes a processor to execute steps of:
providing a plurality of sensors configured to provide substantially real-time data of the area of operation;
combining the substantially real-time data of the area of operation with digital terrain elevation data of the area of operation and positional data of the operator to create a digital cartographic map database having substantially real-real time sensor data;
inputting data regarding the desired viewing perspective within the area of operation with respect to the digital cartographic map database to provide a perspective view image of the area of operation; and
displaying the perspective view image to the operator.

33. The computer readable storage medium of claim 32, wherein the computer program when executed causes the processor to further execute steps of:
receiving updated positional data regarding the operator's current position; and
updating the cartographic map database to reflect the operator's current position based on the updated positional data.

34. The computer readable storage medium of claim 32, wherein the computer program when executed causes the processor to further execute steps of:
receiving updated perspective view data from the operator through six-degree-of-freedom steering inputs; and
updating the displayed perspective view image in accordance with the received updated perspective view data.

35. The computer readable storage medium of claim 32, wherein the plurality sensors includes one or more of the following image sensors: electro-optical (EO) image sensor, infrared (IR) image sensor, intensified or low-light level image sensor, radar three dimensional image sensor, or range data image sensor.

36. The computer readable storage medium of claim 35, wherein the sensor data includes compressed still or motion imagery.

37. The computer readable storage medium of claim 35, wherein the sensor data includes raw still or motion imagery.

38. The computer readable storage medium of claim 32, wherein the computer program when executed causes the processor to further execute step of displaying the perspective view image on one of the following display devices: Cathode Ray Tubes (CRT), flat-panel solid state display, helmet mounted devices (HMD), and optical projection heads-up displays (HUD).

39. The computer readable storage medium of claim 32, wherein the computer program when executed causes the processor to further execute steps of:
creating a remote Tactical Situational Awareness Registry (TSAR) for storing situational awareness data obtained through six-degree-of-freedom location awareness inputs;
and providing the situational awareness data to the operator that is not contained or available locally by the operator.

40. The computer readable storage medium of claim 39, wherein the computer program when executed causes the processor to further execute steps of:
providing a communication path to the operator to acquire the situational awareness data requested by the operator based on a profile of the operator.

41. The computer readable storage medium of claim 32, wherein the computer program when executed causes the processor to further execute step of: creating a three-dimensional digital cartographic map database of the area of operation.

42. The computer readable storage medium of claim 32, wherein the computer program when executed causes the processor to further execute steps of:
receiving a plurality of imagery through an application interface, wherein the imagery includes still and motion imagery in multiple color bands or wavelengths; and
designating a set of metadata corresponding to the plurality of imagery for providing a path into a visual application including the digital cartographic map database.

43. The computer readable storage medium of claim 42, wherein the computer program when executed causes the processor to further execute step of synchronizing the set of metadata with the plurality of imagery.

44. The computer readable storage medium of claim 32, wherein the computer program when executed causes the processor to further execute step of: utilizing the digital cartographic map database to provide a framework for scalable and various degrees of multi-sensor fusion with two-dimensional and three-dimensional RF and EO imaging sensors and other intelligence sources.

45. The computer readable storage medium of claim 32, wherein the computer program when executed causes the processor to further execute step of: adding geo-location data to individual video frames to allow referencing each sensor data with respect to the other imaging sensors and to the digital cartographic map database.

46. The computer readable storage medium of claim 32, wherein the computer program when executed causes the processor to further execute step of: utilizing two-dimensional and three-dimensional RF, imaging and other sensor data as truth source for difference detection against the digital cartographic map database.

47. The computer readable storage medium of claim 32, wherein the computer program when executed causes the processor to further execute step of: seamlessly translating the digital cartographic map data stored on the digital cartographic map database from mission planning/rehearsal simulation into tactical real-time platform and mission environment.
